(19) United States
(12) Patent Application Publication
(10) Pub. No.: US 2007/0020452 A1
(43) Pub. Date: Jan. 25, 2007

(54) Acquisition fiber in sheet form with low degree of yellowing and low odor

(76) Inventors: Othman A. Hamed, Jesup, GA (US); Harry J. Chmielewski, Brunswick, GA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/185,844

(22) Filed: Jul. 21, 2005

(51) Int. Cl. B32B 5/26; B32B 5/06; D04H 1/00

(52) U.S. Cl. 428/359; 442/389; 442/415; 442/414

(57) ABSTRACT

A method for making acquisition fiber in sheet form that exhibits a low degree of yellowing and is substantially free of burnt-like odor. The acquisition fiber may be produced by treating cellulosic fibers in sheet form with a treatment composition solution that includes a cross-linking agent and a modifying agent. After the fibers are impregnated with the treatment composition, the fibers are dried and cured, and then treated with an odor removing agent. The resultant acquisition fiber may be used in absorbent articles, such as personal care products.

### BACKGROUND

1. Field

The embodiments relate, in general to a process for manufacturing acquisition fiber. More particularly, the embodiments relate to a process that provides acquisition fiber in sheet form that exhibits substantially no burnt like odor and a high degree of brightness. The embodiments also relate to a process of using the fiber in personal care products.

2. Description of Related Art

Acquisition fiber is mainly used in absorbent articles intended for body waste management. A layer that is comprised of acquisition fiber typically is positioned between the top sheet and the absorbent core. Absorbent structures incorporating acquisition/distribution layers generally exhibit increased wet resiliency and dry resiliency, better distribution of liquid, increased rate of liquid absorption, and improved surface dryness.

A wide variety of acquisition fibers are known in the art. Included in those are, for example, synthetic fibers, composites of cellulosic fibers or cross-linked fiber and synthetic fibers, or cross-linked cellulosic fibers. Cross-linked cellulosic fiber is preferred because it is made from a renewable starting material, it is biodegradable, and it is relatively inexpensive.

Cross-linked cellulosic fibers and processes for making them have been described in the literature for many years (see, for example, G. C. Tesoro, Cross-Linking of Cellulosics, in Vol. II of Handbook of Fiber Science and Technology, pp. 1-46 (M. Lewin and S. B. Sello eds., Mercel Dekker, New York, 1983)). The cross-linked cellulosic fibers typically are prepared by reacting cellulose with polyfunctional agents that are capable of covalently bonding to at least two hydroxyl groups of the anhydroglucose repeat unit of cellulose in neighboring chains simultaneously.

Cellulosic fibers typically are cross-linked in fluff form. Processes for making cross-linked fiber in fluff form comprise dipping swollen or non-swollen fiber in an aqueous solution of cross-linking agent and a catalyst. The fiber so treated then is usually cross-linked by heating it at elevated temperature in the swollen state, as described in U.S. Pat. No. 3,241,553, or in the collapsed state after defiberizing it, as described in U.S. Pat. No. 3,224,926, and European Patent No. 0,427,361 B1, the disclosures of each of which are incorporated by reference herein in their entirety.

Cellulosic fiber also can be cross-linked in non-aqueous solution. A process for making cross-linked fiber in non-aqueous solution is shown in U.S. Pat. No. 4,035,147 by Sangenis, et al. (this disclosure of which is incorporated by reference herein in its entirety). The patent discloses that cellulosic fibers can be cross-linked by contacting dehydrated, non-swollen fibers with crosslinking agent and a catalyst in a substantially non-aqueous solution that contains an insufficient amount of water to cause the fiber to swell.

Despite the commercial availability and practicality, cross-linked cellulosic fibers have not been widely adopted in absorbent products, seemingly because of the difficulty of successfully cross-linking cellulosic fibers in the sheet form. More specifically, it has been found that cross-linked fiber in the sheet form tends to become more difficult to defiberize without causing substantial problems with the fibers. These problems include severe fiber breakage and increased amounts of knots and nits (hard fiber clumps). Another short-coming is that upon wetting, the cross-linked fiber tends to emit a strong, burnt-like odor that is objectionable to most manufacturers of personal care products. The odor becomes stronger when the fiber is heated while in contact with a conventional cross-linking agent such as, for example, citric acid. This odor has been found to be more common in fibers that have been heated to relatively high temperatures. It is believed that this odor may be related to compounds formed from cellulose and cross-linking agents during the heating process. These compounds can include aldehydes, ketones, acids, and some other organic materials. The cross-linked fiber is unsuitable for many applications in absorbent articles intended for body waste management because of the odor and yellowing.

Efforts to make cross-linked fibers in sheet form have met with limited success. For example, Chatterjee, et al., showed in U.S. Pat. No. 3,932,209 (the disclosure of which is incorporated herein by reference in its entirety) that mercerized fiber having low contents of hemicellulose and lignin can be cross-linked in sheet form without substantial formation of knots and nits. Unfortunately, the use of mercerized fiber to produce cross-linked fiber in sheet form is relatively expensive.

In previous work, (e.g., U.S. patent application Ser. No. 10/683,164 (Publication No. 2005-0079361 A1) entitled “Materials Useful In Making Cellulosic Acquisition Fibers In Sheet Form” filed Oct. 10, 2003, the disclosure of which is incorporated herein by reference in its entirety) it was shown that conventional fibers in sheet form can be successfully cross-linked using modified cross-linking agents. The modified cross-linking agent acts as a cross-linking agent and as a wedge that lowers the inter-fiber bonding and increase fiber bulkiness. This minimized the formation of knots and nits during fiber cross-linking. The resultant cross-linked fibers showed similar or better performance characteristics than conventional individualized cross-linked cellulose fibers.

The description herein of certain advantages and disadvantages of known cellulosic fibers, treatment compositions, and methods of their preparation, is not intended to limit the scope of the embodiments. Indeed, the embodiments may include some or all of the methods, fibers and compositions described above without suffering from the same disadvantages.

### SUMMARY

In view of the difficulties presented by cross-linking cellulosic fibers, there remains a need for a simple, commercially feasible, treatment composition suitable for making acquisition fiber in sheet form. Also a need exists for a cross-linked fiber that is substantially free of burnt like odor. The resultant fiber also preferably should have low contents of knots and nits, a low degree of yellowing, and a high degree of brightness. Preferably, the cross-linked fiber also should be capable of neutralizing the odor caused by bacteria present in the urine. There also exists a need for a process of making acquisition fiber with the properties mentioned above in sheet form. The embodiments described herein desire to fulfill these needs and to provide further related advantages.

It is therefore a feature of an embodiment to provide a method for making acquisition fiber in sheet form having a low degree of yellowing and low odor. The method involves providing a treatment composition solution comprising a cross-linking agent and a modifying agent, providing a cellulosic base fiber in sheet form, applying the treatment composition solution to the cellulosic base fiber to impregnate the sheet of fluff pulp with the treatment composition, drying and curing the impregnated sheet to produce acquisition fiber in sheet form, and thereafter providing an odor removing agent and applying it to the sheet.

It also is a feature of an embodiment to provide an acquisition fiber made by the above-described method. It also is a feature of an embodiment to provide an absorbent article comprising the acquisition fiber.

These and other objects, features and advantages will appear more fully from the following detailed description of the preferred embodiments of the invention.

### DETAILED DESCRIPTION OF PREFERRED EMBODIMENTS

Embodiments provide an acquisition fiber in sheet form being substantially free of a burnt-like odor and having a high degree of brightness. Various embodiments provide a method of making the acquisition fiber. The method includes treating the cellulosic fibers in sheet or roll form with an aqueous solution of a treatment composition, drying and curing the treated fibers, and then treating the fiber with an odor-removing agent.

The acquisition fiber of embodiments should be useful in absorbent articles, and in particular, should be useful in forming acquisition/distribution layers or absorbent cores in absorbent articles. The particular construction of the absorbent article is not critical, and any absorbent article can benefit from the embodiments. Suitable absorbent garments are described, for example, in U.S. Pat. Nos. 5,281,207, and 6,068,620, the disclosures of each of which are incorporated by reference herein in their entirety including their respective drawings. Those skilled in the art will be capable of utilizing acquisition fiber of the embodiments in absorbent garments, cores, acquisition layers, and the like, using the guidelines provided herein.

As used herein, the terms and phrases “absorbent garment,” “absorbent article” or simply “article” or “garment” refer to mechanisms that absorb and contain body fluids and other body exudates. More specifically, these terms refer to garments that are placed against or in proximity to the body of a wearer to absorb and contain the various exudates discharged from the body. A non-exhaustive list of examples of absorbent garments includes diapers, diaper covers, disposable diapers, training pants, feminine hygiene products and adult incontinence products. Such garments may be intended to be discarded or partially discarded after a single use (“disposable” garments). Such garments may comprise essentially a single inseparable structure (“unitary” garments), or they may comprise replaceable inserts or other interchangeable parts.

Embodiments may be used with all of the foregoing classes of absorbent garments, without limitation, whether disposable or otherwise. Some of the embodiments described herein provide, as an exemplary structure, a diaper for an infant, however this is not intended to limit the claimed invention. The embodiments will be understood to encompass, without limitation, all classes and types of absorbent garments, including those described herein.

Throughout this description, the term “disposed” and the expressions “disposed on,” “disposed above,” “disposed below,” “disposing on,” “disposed in,” “disposed between” and variations thereof are intended to mean that one element can be integral with another element, or that one element can be a separate structure bonded to or placed with or placed near another element. Thus, a component that is “disposed on” an element of the absorbent garment can be formed or applied directly or indirectly to a surface of the element, formed or applied between layers of a multiple layer element, formed or applied to a substrate that is placed with or near the element, formed or applied within a layer of the element or another substrate, or other variations or combinations thereof.

Throughout this description, the term “impregnated” insofar as it relates to a treatment composition impregnated in a fiber, denotes an intimate mixture of treatment composition and cellulosic fiber, whereby the treatment composition may be adhered to the fibers, adsorbed on the surface of the fibers, or linked via chemical, hydrogen or other bonding (e.g., Van der Waals forces) to the fibers. Impregnated in the context of the embodiments described herein does not necessarily mean that the treatment composition is physically disposed beneath the surface of the fibers.

Throughout this description, the expression “acquisition fiber” as used herein refers to a cross-linked cellulosic fiber suitable for use in the acquisition/distribution layer of an absorbent article intended for body waste management. The acquisition fiber imparts bulk and resilience to the layer and provides the layer with a generally open structure that is rapidly absorb the liquid from the point of insult and distributes it over a large area in the storage layer.

The expression “pulp sheet” as used herein refers to cellulosic fiber sheets formed using a wet-laid process. The sheets typically have a basis weight of about 200 to about 800 gsm and density of about 0.15 g/cc to about 1.0 g/cc. The pulp sheets are subsequently defiberized in a hammermill to convert them into fluff pulp before being used in an absorbent product. Pulp sheets can be differentiated from tissue paper or paper sheets by their basis weights. Typically, tissue paper has a basis weight of from about 5 to about 50 gsm and paper sheets have basis weights of from about 47 to about 103 gsm, both lower than that of pulp sheets.

In accordance with embodiments, the treatment composition that is useful in making acquisition fiber in sheet form comprises a cross-linking agent and a modifying agent.

Any cross-linking agent known in the art that is capable of cross-linking the cellulosic fibers can be used in the treatment composition of the embodiments described herein. Suitable cross-linking agents include, for example, alkane polycarboxylic acids, polymeric polycarboxylic acids, aldehydes, and urea-based derivatives. Suitable alkane polycarboxylic acids include, for example, aliphatic and alicyclic polycarboxylic acids containing at least two carboxylic acid groups. The aliphatic and alicyclic polycarboxylic acids could be either saturated or unsaturated, and they might also contain other heteroatoms such as sulfur, nitrogen or halogen. Examples of suitable polycarboxylic acids include: 1,2,3,4-butanetetracarboxylic acid, 1,2,3-propanetricarboxylic acid, oxydisuccinic acid, citric acid, itaconic acid, maleic acid, tartaric acid, glutaric acid, iminodiacetic acid, citraconic acid, tartrate monosuccinic acid, benzene hexacarboxylic acid, cyclohexanehexacarboxylic acid, maleic acid, and any combinations or mixtures thereof.

Suitable polymeric polycarboxylic acid cross-linking agents include, for example, those formed from monomers and/or co-monomers that contain carboxylic acid groups or functional groups that can be converted into carboxylic acid groups. Such monomers include, for example, acrylic acid, vinyl acetate, maleic acid, maleic anhydride, carboxy ethyl acrylate, itanoic acid, fumaric acid, methacrylic acid, crotonic acid, aconitic acid, tartrate monosuccinic acid, acrylic acid ester, methacrylic acid ester, acrylic amide, methacrylic amide, butadiene, styrene, or any combinations or mixtures thereof.

Examples of suitable polymeric polycarboxylic acids include polyacrylic acid and polyacrylic acid copolymers such as, for example, poly(acrylamide-co-acrylic acid), poly(acrylic acid-co-maleic acid), poly(ethylene-co-acrylic acid), and poly(1-vinylpyrolidone-co-acrylic acid), as well as other polyacrylic acid derivatives such as poly(ethylene-co-methacrylic acid) and poly(methyl methacrylate-co-methacrylic acid). Other examples of suitable polymeric polycarboxylic acids include polymaleic acid and polymaleic acid copolymers such as, for example, poly(methyl vinyl ether-co-maleic acid), poly(styrene-co-maleic acid), and poly(vinyl chloride-co-vinyl acetate-co-maleic acid). The representative polycarboxylic acid copolymers noted above are commercially available in various molecular weights.

Suitable aldehyde cross-linking agents include, for example, formaldehyde, glyoxal, glutaraldehyde, glyoxylic acid and glyceraldehydes. Suitable urea-based derivatives for use in the present invention include, for example, urea based-formaldehyde addition products, such as, for example, methylolated ureas, methylolated cyclic ureas, methylolated lower alkyl cyclic ureas, methylolated dihydroxy cyclic ureas, dihydroxy cyclic ureas, and lower alkyl substituted cyclic ureas. Especially preferred urea-based crosslinking agents include dimethyldihydroxy urea (DMDHU, or 1,3-dimethyl-4,5-dihydroxy-2-imidazolidinone), dimethyloldihydroxyethylene urea (DMDHEU, or 1,3-dihydroxymethyl-4,5-dihydroxy-2-imidazolidinone), dimethylol urea (DMU, or bis[N-hydroxymethyl]urea), dihydroxyethylene urea (DHEU, or 4,5-dihydroxy-2-imidazolidinone), dimethylolethylene urea (DMEU, or 1,3-dihydroxymethyl-2-imidazolidinone), and dimethyldihydroxyethylene urea (DDI, or 4,5-dihydroxy-1,3-dimethyl-2-imidazolidinone). Other suitable substituted ureas include glyoxal adducts of ureas, polyhydroxyalkyl urea disclosed in U.S. Pat. No. 6,290,867, and hydroxyalkyl urea and β-hydroxyalkyl amide disclosed in U.S. Pat. No. 5,965,466.

Alternatively, a cross-linking agent suitable for use herein may be comprised of any combination or mixture of two or more of the above mentioned cross-linking agents.

The expression “modifying agent” as used herein refers to a material that is polymeric or monomeric, and that can function as an anti-hydrogen bonding agent and debonder. Examples of suitable modifying agents for use in the treatment composition include polyhydroxy organic compounds, polyfunctional epoxy compounds, and silicon-based anti-hydrogen-bonding agents.

Suitable polyhydroxy organic compounds include materials with multiple hydroxyl groups and the ether- and ester-derivatives of the polyhydroxy compounds. The polyhydroxy compounds preferably contain hydrophobic alkyl group with 3 or more carbon atoms. The alky group could be saturated, unsaturated (e.g., alkenyl, alkynyl, allyl), substituted, un-substituted, branched and un-branched, cyclic, and acyclic compounds. Examples of polyhydroxy organic compounds include, but are not limited to: 1,4-cyclohexanedimethanol, 1,3-cyclohexanedimeathonol, 1,2-cyclohexanedimethanol, diacetin, triacetin, tri(propylene glycol), di(propylene glycol), tri(propylene glycol) methyl ether, tri(propylene glycol) butyl ether, tri(propylene glycol) propyl ether, di(propylene glycol) methyl ether, di(propylene glycol) butyl ether, di(propylene glycol) propyl ether, di(propylene glycol) dimethyl ether, 2-phenoxyethanol, propylene carbonate, propylene glycol diacetate, and combinations and mixtures thereof. Other suitable modifying agents for use in the present invention include the alkyl ethers and alkyl acid esters of citric acid. Preferred modifying agents include cyclohexanedimethanol, tri(propylene glycol) methyl ether, and tri(propylene glycol) propyl ether.

A polyfunctional epoxy that may be used in embodiments preferably has one of the following general formulas:

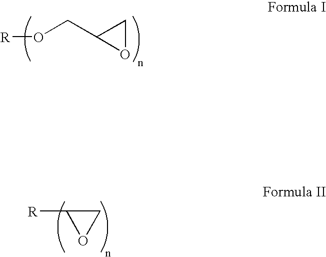

In Formulas I and II, R represents an alkyl with 3 or more carbon atoms; “n” is the number of repeating units in the material, and is a number from 1 to 4. The alkyl group may include saturated, unsaturated, substituted, un-substituted, branched, un-branched, cyclic, and/or acyclic compounds.

Typical examples of such polyfunctional epoxies include but are not limited to: 1,4-cyclohexanedimethanol diglycidyl ether, diglycidyl 1,2-cyclohexanedicarboxylate, diglycidyl 1,2,3,4-tetrahydrophthalate, glycerol propoxylate triglycidyl ether, 1,4-butanediol diglycidyl ether, neopentyldiglycidyl ether, polypropyleneglycol diglycidyl ether, or any combination thereof. Especially preferred polyfunctional epoxies are 1,4-cyclohexanedimethanol diglycidyl ether and neopentyldiglycidyl ether.

The phrase “silicon-based anti-hydrogen-bonding agent” as used herein refers to quaternary ammonium terminated polysiloxanes that are water soluble or water dispersible, and that are able to alter the formation of hydrogen bonding among cellulosic fibers that are sheeted and compressed. Examples of anti-hydrogen-bonding agents suitable for use in the treatment composition of the present invention are represented by Formulas III and IV below.

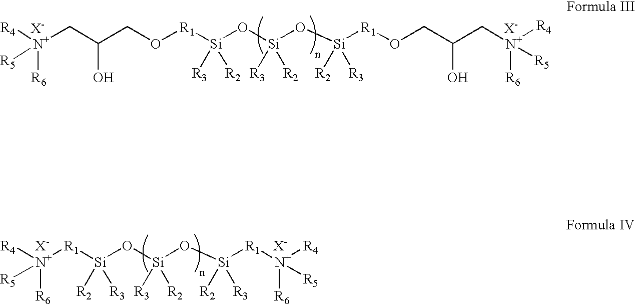

In Formulas III and IV, R₁ represents a divalent alky group with two or more carbon atoms that can be branched or cyclic. Optionally R₁ can be a polyether or co-polyether substituted with one or more hydroxyl groups. R₂ and R₃, each independently represent an alkyl group with one or more carbon atoms that can be branched or cyclic where preferably at least one of the alky groups is a polyether group or co-polyether terminated with a hydroxyl group. R₅ to R₆ each independently represent a hydrogen atom or an organic group, where the organic group is an alkyl, aryl, alkoxy, alkaryl substituted alkyl, cycloaliphatic, aromatic, or a mixture thereof. Preferably at least one of these organic groups is hydroxyl terminated. In Formulas I and II, X represents an anion, such as a halogen ion, an organic carboxylate, hydroxyl, or a compound with general formula of RSO₃—. In Formulas III and IV, “n” represents the number of repeating units in the polymer chain, and is a number from 10 to 200.

Quaternary ammonium terminated polysiloxanes characterized by Formula III can be synthesized as shown in Scheme I below by reacting an epoxy terminated polysiloxane with organic amines. Examples of epoxy terminated polysiloxanes include poly(dimethylsiloxane), diglycidyl ether terminated. Any organic amines that are aliphatic linear, branched or cyclic amines containing at least one primary, secondary or tertiary amino group can be used in the present invention. Preferably, the amines are polyamines terminated with only one amine group. More preferably, the amines are secondary and containing at least one hydroxyl group. Examples of suitable organic amines include but are not limited to diethylamine, ethanolamine, diethanolamine, bis-2-hydroxypropylamine, bis-3-hydroxypropylamine, triethanolamine, tris-2-hydroxypropylamine, N-methylethanolamine, N-benzylethanolamine, N,N-dimethylethanolamine, piperidine, and morpholine. Primary amines and polyamines tend to form with poly(dimethylsiloxane), diglycidyl ether terminated cross-linked three-dimensional polymer which is insoluble in most solvent.

In one embodiment, the organic amine and epoxy terminated polysiloxane, respectively, are preferably employed in an equivalent ratio of about 1.0 to 2.0. Throughout this description, the expression “equivalent ratio” refers to the equivalent weight of organic amine to the equivalent weight of epoxy terminated polysiloxane. Equivalent weight of amine is equal to molecular weight of amine divided by number of amine hydrogens. Equivalent weight of epoxy terminated polysiloxane is equal to molecular weight of the epoxy divided by number of epoxy groups.

The reaction between amine and epoxy terminated polysiloxane preferably is conducted at room temperature for overnight, and more preferably the reaction is conducted at 50° C. to about 100° C. for about six hours.

In a preferred embodiment, the organic amine is diethanol amine and the polysiloxane is poly(dimethylsiloxane), diglycidyl ether terminated. Scheme I shows a representative example for making quaternary ammonium terminated polysiloxane with Formula III by reacting diethanolamine with poly(dimethylsiloxane) diglycidyl ether terminated, in stoichiometric proportions based on equivalent weight, preferably with a slight excess of the diethanol amine present.

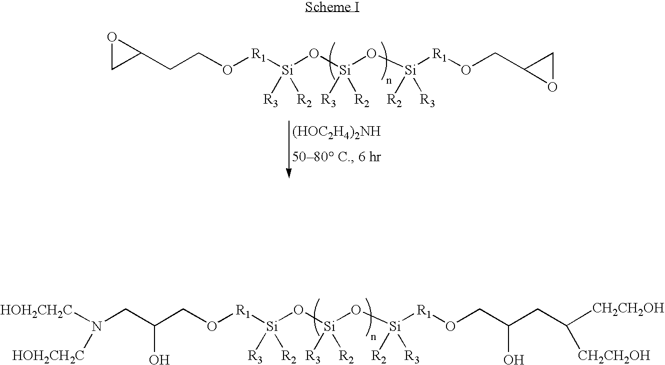

Suitable silicon polymer compounds with terminal amines shown in Formula IV include poly(dimethylsiloxanebis[[3-[(2-aminoethyl)amino]propyl]dimethoxysilylether; poly(dimethylsiloxane), bis(3-aminopropyl) terminated; poly[dimethylsiloxane-co-(3-aminopropyl)methylsiloxane]; and the QUATERNIUM-80 marketed by Goldschmidt under the trademark Abil® Quat 3270, 3272, and 3474.

A silicon polymer compound terminated with amines can be converted into ammonium prior to mixing it with the cross-linking agent by treating it with an acid. Inorganic or organic acids are suitable for this purpose. Especially preferred acids include acetic acid, formic acid, phosphoric acid, citric acid, hydrochloric acid, glycolic acid, malic acid, lactic acid and glyoxylic acid. Preferably, the silicon polymer compound terminated with amines is used without acidification, since the acidification preferably takes place upon mixing it with the polycarboxylic acid cross-linking agent to make the treatment composition solution.

Preferably, a suitable modifying agent may be comprised of any combination or mixture of two or more of the above mentioned modifying agent. More preferably the modifying agent is selected from group consisting of 1,4-cyclohexanedimethanol (CHDM), 1,4-cyclohexanedimethanol diglycidyl ether, and silicon-based anti-hydrogen-bonding agent represented by formulas I and II. Most preferably the modifying agent is 1,4-cyclohexanedimethanol diglycidyl ether (1,4-CHDMDGE).

In accordance with embodiments, the treatment composition that is useful in making acquisition fiber in sheet form is made by reacting or mixing a cross-linking agent and a modifying agent. For instance, in the case where the modifying agent is 1,4-CHDMDGE and the cross-linking agent is alkane polycarboxylic acid containing a hydroxyl group, preferably the modifying agent and the cross-linking agent are reacted, then used to make an acquisition fiber. The reaction may be carried out within the temperature range of room temperature up to reflux. Preferably, the reaction is carried out at room temperature for about 6 hours, more preferably for about 10 hours and most preferably for about 16 hours. The respective components generally are reacted in a mole ratio of polycarboxylic acid to polyfunctional epoxy of about 2.0:1.0 to about 4.0:1.0. Optionally, a catalyst may be added to the solution to accelerate the reaction between the polycarboxylic acid and the polyfunctional epoxy. Preferably, the catalyst is a Lewis acid selected from aluminum sulfate, magnesium sulfate, and any Lewis acid that contains at least a metal and a halogen, including, for example FeCl3, AlCl₃, and MgCl₂. Preferably the reaction is carried out at room temperature for more than 6 hours. Usually the product of the reaction is water-soluble, and can be diluted in water to any desirable concentration.

The treatment composition of the embodiments may be prepared by any suitable and convenient procedure. The cross-linking agent and the modifying agent are generally mixed in a weight ratio of cross-linking agent to modifying agent of about 1:1 to about 6:1. Preferably, the treatment composition is present in an aqueous solution, diluted with water to a predetermined concentration. When silicon-based anti-hydrogen-bonding agent is used as the modifying agent, it is preferred that the cross-linking agent and the modifying agent are mixed in a weight ratio of cross-linking agent to modifying agent of about 1:1 to about 100:1, and more preferably from about 1:1 to 50:1.

Without being limited to a specific theory, the modifying agent appears to act as a wedging agent because of the bulky hydrophobic group that disrupts the inter-fiber hydrogen bonding (fiber-to-fiber bonding)—as a result, voids are created among the fibers. These voids enhance the bulk of the fibers, thereby producing a softer and weaker sheet of cross-linked wood pulp that can be more easily processed into individual fibers without excessive fiber breakage.

The treatment composition of embodiments may advantageously be used to make acquisition fiber from conventional fluff pulp in sheet form. Acquisition fiber made in sheet form in accordance with embodiments enjoy the same or better performance characteristics as conventional individualized cross-linked cellulose fibers, but avoids the processing problems associated with dusty individualized cross-linked fibers.

Another embodiment provides a method for making acquisition fiber using the treatment composition described herein. The process preferably comprises treating cellulosic base fibers in sheet or roll form with an aqueous treatment composition solution to impregnate the cellulosic base fiber, followed by drying and curing the impregnated fiber at sufficient temperature and for a sufficient period of time to accelerate formation of covalent bonding between hydroxyl groups of cellulosic fibers and functional groups of the treatment composition.

The aqueous treatment composition solution comprises the treatment composition described herein. The treatment composition solution may be prepared by any suitable and convenient procedure. Preferably the treatment composition is present in solution in a concentration of about 2.5 weight % to about 8.0 weight %, based on the total weight of the solution. Preferably the treatment composition is diluted to a concentration sufficient to provide from about 0.5 weight % to about 10.0 weight % of treatment composition on fiber, more preferably from about 2.0 weight % to about 7.0 weight %, and most preferably from about 3.0 weight % to about 6.0 weight %. By way of example, 7 weight % treatment composition is equal to 7 grams of treatment composition per 100 grams oven dried fiber.

The treatment composition solution preferably includes a catalyst to accelerate the reaction between hydroxyl groups of cellulose and treatment composition functional groups carboxyl. Any catalyst known in the art to accelerate the formation of an ester bond between hydroxyl group and carboxylic acid group or ether bond between the hydroxyl group and aldehyde group may be used. Suitable catalysts for use in the present invention include alkali metal salts of phosphorous containing acids such as alkali metal hypophosphites, alkali metal phosphites, alkali metal polyphosphonates, alkali metal phosphates, and alkali metal sulfonates. A particularly preferred catalyst is sodium hypophosphite. The catalyst can be applied to the fiber as a mixture with the treatment composition, before the addition of the treatment composition, or after the addition of treatment composition to the cellulosic fiber. A suitable weight ratio of catalyst to treatment composition is, for example from about 1:1 to about 1:10, and preferably from about 1:3 to about 1:6.

Preferably, the pH of the treatment composition solution is adjusted to from about 1 to about 5, more preferably from about 1.5 to about 3.5. The pH can be adjusted using alkaline solutions such as, for example, sodium hydroxide or sodium carbonate.

Applicants have discovered that acidic acquisition fiber can be made using a solution of the treatment composition as-is (i.e., without neutralization). Preferably the solution treatment composition is used without a catalyst.

The phrase “acidic acquisition fiber” as used herein refers to acquisition fiber with a pH below 3.5 as determined according to a procedure reported in the example section. Acidic acquisition fiber may advantageously be used to make acquisition layer for personal care product capable of neutralizing the odor produced by bacteria in urine.

The cellulosic base fiber may be any conventional or other cellulosic fiber, so long as it is capable of providing the desired physical characteristics. Suitable cellulosic fiber for use in forming the acquisition fiber includes that primarily derived from wood pulp. Suitable wood pulp can be obtained from any of the conventional chemical processes, such as the Kraft and sulfite processes. Preferred fiber is that obtained from various soft wood pulp such as Southern pine, White pine, Caribbean pine, Western hemlock, various spruces, (e.g. Sitka Spruce), Douglas fir or mixtures and combinations thereof. Fiber obtained from hardwood pulp sources, such as gum, maple, oak, eucalyptus, poplar, beech, and aspen, or mixtures and combinations thereof also can be used vention. Other cellulosic fiber derived from cotton linter, bagasse, kemp, flax, and grass also may be used in the present invention. The cellulosic base fiber can be comprised of a mixture of two or more of the foregoing cellulosic pulp products. Particularly preferred fibers for use in forming the acquisition fiber are those derived from wood pulp prepared by the Kraft and sulfite-pulping processes. In addition, the cellulosic base fiber may be non-bleached, partially bleached or fully bleached cellulosic fiber.

The cellulosic base fibers can be provided in any of a variety of forms. For example, one embodiment contemplates using cellulosic base fibers in sheet or roll form. In another embodiment, the fiber can be provided in a mat of non-woven material. Fibers in mat form are not necessarily rolled up in a roll form, and typically have a density lower than fibers in sheet form. In yet another feature of an embodiment, the cellulosic base fiber is provided in a wet or dry state. It is preferred that the cellulosic base fibers be provided dry in a roll form.

The cellulosic base fiber that is treated in accordance with various embodiments while in the sheet form can be any of wood pulp fibers or fiber from any other source described previously. In one embodiment, fibers in the sheet form suitable for use include caustic-treated fibers.

A description of the caustic extraction process can be found in Vol. V, Part 1 of Cellulose and Cellulose Derivatives, (Ott, Spurlin, and Grafllin, eds., Interscience Publisher 1954). Briefly, the cold caustic treatment is carried out at a temperature less than about 65° C., but preferably at a temperature less than 50° C., and more preferably at a temperature between about 10° C. to 40° C. A preferred alkali metal salt solution is a sodium hydroxide solution either newly made up or as a solution by-product from a pulp or paper mill operation, e.g., hemicaustic white liquor, oxidized white liquor and the like. Other alkali metals such as ammonium hydroxide and potassium hydroxide and the like may be employed. However, from a cost standpoint, the preferred alkali metal salt is sodium hydroxide. The concentration of alkali metal salts in solution is generally in a range from about 2 to about 25 weight percent of the solution, preferably from about 3 to about 18 weight percent.

In one embodiment of the present invention, the cellulosic base fiber is a caustic-treated fiber that has been prepared by treating a liquid suspension of pulp at a temperature of from about 5° C. to about 85° C. with an aqueous alkali metal salt solution for a period of time ranging form about 5 minutes to about 60 minutes.

Commercially available caustic extractive pulp suitable for use in embodiments include, for example, Porosanier-J-HP, available from Rayonier Performance Fibers Division (Jesup, Ga.), and Buckeye's HPZ products, available from Buckeye Technologies (Perry, Fla.).

Any method of applying the treatment composition solution to the fiber in sheet form may be used, so long as it is capable of providing an effective amount of treatment composition to the fiber to produce the acquisition fiber described herein. Preferably, the application method provides about 10% to about 150% by weight of solution to the fiber, based on the total weight of the fiber. Acceptable methods of application include, for example, spraying, dipping, impregnation, and the like. Preferably, the fiber is impregnated with the aqueous treatment composition solution. Impregnation typically creates a uniform distribution of treatment composition on the sheet and provides better penetration of treatment composition into the interior part of the sheet. Preferably, the treatment composition solution is applied to the cellulosic fibers to provide about 2% to about 7% by weight, and more preferably about 3% to about 6% by weight of treatment composition on fiber, based on the total weight of the fiber.

In one embodiment, a sheet of cellulose fibers in roll form is conveyed through a treatment zone where the treatment composition is applied on both surfaces by conventional methods such as spraying, rolling, dipping, knife-coating, slot-coating, or any other manner of impregnation. A preferred method of applying the treatment composition solution to the fiber in roll form is by puddle press or size press.

In one embodiment, the fiber in sheet or roll form, after having been treated with a solution of the treatment composition, then is preferably transported by a conveying device such as a belt or a series of driven rollers through a three-zone oven for drying and curing. For example, curing typically is conducted in a forced draft oven.

After treatment with the solution of the treatment composition, the fiber preferably is dried and cured in a two-stage process, and more preferably dried and cured in a one-stage process. Such drying and curing removes water from the fiber, thereupon inducing the formation of a linkage between hydroxyl groups of the cellulosic fibers and cross-linking agent. Any curing temperature and time can be used so long as they produce the desired effects described herein. Using the present disclosure, persons having ordinary skill in the art can determine suitable drying and curing temperatures and times, depending on the type of fiber, the type of treatment of the fiber, and the desired bonding density of the fiber.

It is preferred that the cellulosic fiber is dried and cured in a one-step process, for a period of time ranging from about 3 minutes to about 15 minutes at temperatures within the range of 130° C. to about 225° C. Alternatively, the drying and curing may be conducted in a two-step process. In this case, in the drying step dries the impregnated cellulosic fiber, and the dried cellulose fiber then is cured to form intra-fiber bonds. In one embodiment where the curing and drying are carried out in a two-step process, the drying step is carried out at a temperature below the curing temperature (e.g., between room temperature and about 150° C.) before the curing step. The curing step is then carried out, for example, for about 1 to 10 minutes at a temperature within the range of 150° C. to about 225° C. Alternately, the curing step may be carried out for about 0.5 minutes to about 5 minutes at a temperature range of about 130° C. to about 225° C.

After drying and curing, the acquisition fiber preferably is treated with enough water to increase the moisture content of the acquisition fiber to about 5% to about 10% based on the fiber weight. Preferably, the water is added to the acquisitions fiber by spraying, rolling, slot-coating or printing. Treating the acquisition fiber with water significantly reduces the burnt-like odor and fines content of the acquisition fiber.

Heating the cellulosic fibers treated with conventional cross-linking agent(s) at high temperature for curing (typically around 195° C. for 10-15 minutes) tends to cause the fiber to discolor and to have a strong burnt-like odor. Surprisingly, acquisition fiber made in accordance with these embodiments shows a low degree of yellowing and high degree of brightness. Preferably, the treated acquisition fiber has an ISO Brightness of greater than about 77%, when measured according to the test method provided herein.

The burnt-like odor produced with the fiber when it is heated during the curing process can be removed by treating the fiber with an odor removing agent that may include oxidizing agents used in wood pulping and bleaching processes such as for example, hydrogen peroxide, chlorine dioxide, peracetic acid, perbenzioc acid, chlorine, chlorine dioxide, ozone, sodium hypochorite and any combination thereof. Other suitable odor removing agents for use in the embodiments include those commercial odor removers used to remove odors such as pet odor, smoke, sweat and the like, from carpets, kitchen, vehicles, bathrooms, garbage pails and disposals, laundry shoes, sport equipment, sewer. Examples of these commercial odor removers include baking soda, talc powder, cyclodextrin, ethylenediamine tetra-acetic acid or other chelating agents, zeolites, activated silica, activated carbon granules, and odor-removing formulas such as DOUBLE-O® and UN-DUZ-IT® (manufactured by II Rep-Z Inc., Coraopolis, Pa.), X-O® (manufactured by X-O Corporation, Dallas, Tex.), and NOK-OUT® (manufactured by Amazing Concepts, LLC. Beaverton, Mich.).

Preferably the odor removing agent is one of the following: oxidizing agents used in wood pulping and bleaching, cyclodextrin, UN-DUZ-IT, X-O, or a combination or mixture of thereof. More preferably the odor removing agent is hydrogen peroxide or β-cyclodextrin (β-CD). Hydrogen peroxide and β-CD seem to perform dual functions—in addition to removing the burnt-like odor, they enhance the pulp brightness (see Table 6 below).

When hydrogen peroxide is used as an odor remover, it preferably is combined with an activating agent such as, for example, a transition metal complex, or N,N,N′N′-tetraacetylethylene diamine reagent. Preferably the activating agent is an iron reagent. Preferably the iron agent is applied to the fiber with the treatment composition solution. The iron reagent preferably is applied to the fiber at a concentration ranging from about 0.001% to about 0.5% by weight based on the fiber weight. Suitable iron reagents for use in the embodiments can be selected from a group of compounds consisting of ferric pyrophosphate, ferrous oxalate, ferric citrate, ferrous sulfate, ferric ammonium citrate, ferric orthophosphate, ferric ammonium oxalate, ferric ammonium sulfate, ferric bromide, ferric sodium oxalate, ferric stearate, ferric sulfate, ferrous acetate, ferrous ammonium sulfate, ferrous bromide, ferrous gluconate, ferrous iodide, ferric acetate, ferric fluoroborate, ferric hydroxide, ferric oleate, ferrous fumarate, ferrous oxide, ferric lactate, ferric resinate, and any combination thereof.

If acquisition fiber with a high degree of yellowing is preferred, the fiber may be treated with only the iron reagent. The iron preferably is applied to the fiber with the solution of the treatment composition at a concentration range from about 0.001% to about 0.5% by weight based on fiber weight.

Preferably, the odor removing agent is applied to the acquisition fiber in an aqueous solution to provide about 0.001% to about 1.0% by weight of the agent, based on the weight of the fiber. More preferably, the agent is applied to provide about 0.05% to about 1.0% by weight of the agent, based on the weight of the fiber.

The application of odor removing agent to acquisition fiber in sheet form may be performed in a number of ways. One embodiment provides a method of applying the solution of odor removing agent by dipping the acquisition fiber into an odor removing solution, pressing the dipped fiber to remove excess solution, and drying the fiber at a temperature below 320° F. Alternative methods of applying the odor removing agent to the acquisition fiber include spraying, rolling, slot coating, or printing. Yet another alternative application method is spraying the odor removing solution onto defiberized acquisition fiber fluff pulp during the manufacturing of an absorbent core. Preferably, the odor-removing solution is sprayed onto acquisition fiber in sheet form immediately after curing. It should be noted that application of an odor removing agent to the acquisition fiber is not limited to application in solution, and may also include application in an emulsion, suspension or dispersion thereof.

The amount of solution necessary to deliver an effective amount of the odor removing agent to the fiber will vary depending, for example, on the concentration of the solution and the application method. For instance, when a sheet of acquisition fiber is impregnated with a solution of odor removing agent having a concentration of about 0.01% to about 20.0% of the odor removing agent and then the impregnated solution is dried, the solution of odor removing agent preferably is applied to the acquisition fiber to provide from about 10% to about 150% by weight of solution to the fiber, based on the total weight of the fiber. In comparison, when the same solution of odor removing agent is slot-coated onto one surface of the sheet of acquisition fiber, the solution preferably is applied to the acquisition fiber to provide from about 1% to about 15% by weight of solution on fiber, based on the total weight of the fiber. One of ordinary skill in the art would be able to determine, based on the application method used and additional guidance provided herein, the appropriate amount and concentration of solution necessary to provide the effective amount of odor removing agent to the fiber.

The cellulosic fibers modified in accordance with various embodiments preferably possess characteristics that are desirable in absorbent articles. For example, the acquisition fiber preferably has a centrifuge retention capacity of less than about 0.65 grams of synthetic saline per gram of oven dried (OD) fibers (hereinafter “g/g OD”). The acquisition fiber also has other desirable properties, such as absorbent capacity of greater than about 10.0 g/g OD, an absorbency under load of greater than about 8.0 g/g OD, and less than about 10.0% of fines. In addition, acidic acquisition fiber may be desirable for use in absorbent articles because of its ability to neutralize odors produced by bacteria present in urine.

The centrifuge retention capacity measures the ability of the fiber to retain fluid against a centrifugal force. The absorbent capacity measures the ability of the fiber to absorb fluid without being subjected to a confining or restraining pressure. The absorbency under load measures the ability of the fiber to absorb fluid against a restraining or confining force over a given period of time.

The properties of the acquisition fiber prepared in accordance with the embodiments make the fiber suitable for use, for example, as a bulking material, in the manufacturing of high bulk specialty fiber that requires good absorbency and porosity. The acquisition fiber can be used, for example, in non-woven, fluff absorbent products. The acquisition fiber may also be used independently, or preferably incorporated with other cellulosic fibers to form blends using conventional techniques, such as air laying techniques.

The acquisition fiber of the various embodiments may be incorporated into various absorbent articles, preferably intended for body waste management such as adult incontinent pads, feminine care products, and infant diapers. The acquisition fiber can be used as an acquisition/distribution layer in the absorbent articles, and it can be utilized in the absorbent core of the absorbent articles. Towels and wipes and other absorbent products such as filters also may be made with the acquisition fiber of the embodiments. Accordingly, an additional feature of the embodiments described herein is to provide an absorbent article and an absorbent core that includes the acquisition fiber.

In accordance with additional embodiments, the acquisition fiber may be incorporated into an acquisition layer of an absorbent article. When the resultant absorbent article is evaluated by the Specific Absorption Rate Test (SART), which is described in more detail below, the absorbent article containing acquisition fiber exhibits results comparable to those obtained by using commercially cross-linked fiber, especially those fibers cross-linked in individualized form with polycarboxylic acid reagents.

The acquisition fiber also may be used in an absorbent core of an absorbent article. The phrase “absorbent core” as used herein refers to a matrix of cellulosic wood fluff pulp, or other fiber, intended to absorb large quantities of fluid. Absorbent cores can be designed in a variety of ways to enhance fluid absorption and retention properties such as, for example, disposing superabsorbent materials amongst fibers of wood pulp. The absorbent core may be used as a component of consumer products such as diapers, feminine hygiene products or incontinence products.

A method of making an absorbent core comprising acquisition fiber may include forming a pad of acquisition fiber or a mixture of acquisition fiber and other fiber, and incorporating particles of superabsorbent polymer into the pad. The pad can be wet laid or airlaid. Preferably the pad is airlaid. It also is preferred that the SAP and acquisition fiber (or a mixture of acquisition fiber and other fiber) are air-laid together.

The expression “superabsorbent polymer” or “SAP” as used herein refers to a polymeric material that is capable of absorbing large quantities of fluid by forming a hydrated gel. Superabsorbent materials are well-known to those skilled in the art as substantially water-insoluble, absorbent polymeric compositions that are capable of absorbing large amounts of fluid ((0.9% solution of NaCl in water) and/or blood) in relation to their weight and forming hydrogel upon such absorption. An absorbent core of the present invention may comprise any SAP known in the art. The SAP can be in the form of particulate matter, flakes, fibers and the like. Exemplary particulate forms include granules, pulverized particles, spheres, aggregates and agglomerates. Exemplary and preferred superabsorbent materials include salts of crosslinked polyacrylic acid such as sodium polyacrylate.

It is preferred in embodiments of the present invention that the acquisition fiber is present in the absorbent core in an amount ranging from about 10% to about 80% by weight, based on the total weight of the core. More preferably, the acquisition fiber is present in an absorbent core from about 20% to about 60% by weight.

The absorbent core may comprise one or more layers that may comprise acquisition fiber. In one embodiment, one or more layers of the absorbent core comprise a mixture of acquisition fiber with conventional cellulosic fibers and SAP. Preferably, the acquisition fiber of the embodiments is present in the fiber mixture in an amount ranging from about 1% to 70% by weight, based on the total weight of the fiber mixture, and more preferably present in an amount ranging from about 10% to about 40% by weight. Any conventional cellulosic fiber may be used in combination with the acquisition fiber. Suitable conventional cellulosic fibers include any of the wood fibers mentioned previously herein, including caustic-treated fibers, rayon, cotton linters, and mixtures and combinations thereof.

In one embodiment, the absorbent core may have an upper layer comprising acquisition fiber, and a lower layer comprising a composite of cellulosic fibers and superabsorbent polymer. In this embodiment, the upper layer preferably has a basis weight of about 40 gsm to about 400 gsm. The upper layer and the lower layer of the absorbent core may have the same overall length and/or the same overall width. Alternately, the upper layer may have a length that is longer or shorter than the length of the lower layer. Preferably, the length of the upper layer is 20% to 100% the length of the lower layer. The upper layer may have a width that is wider or narrower than the width of the lower layer. Preferably, the width of the upper layer is 80% the width of the lower layer.

The upper layer may comprise a mixture of conventional fiber and acquisition fiber. Preferably the conventional fiber is present in the fiber mixture in an amount ranging from about 1% to about 70% by weight, based on the total weight of the upper layer, more preferably present in an amount ranging from about 5% to about 60% by weight, and most preferably present in an amount ranging from about 10% to about 50% by weight. Any conventional cellulosic fiber may be used in combination with the acquisition fiber of the embodiments. Suitable conventional cellulosic fibers include any of the wood fibers mentioned previously herein, mercerized (cold caustic-treated) fibers, rayon, cotton linters, and mixtures and combinations thereof. Preferably the conventional fiber is mercerized fiber.

The upper layer may also contain SAP. Preferably the SAP is present in an amount ranging from about 1% to about 30% based on the total weight of the upper layer (acquisition/distribution layer).

Each layer of the absorbent core may comprise a homogeneous composition, where the acquisition fiber is uniformly dispersed throughout the layer. Alternatively, the acquisition fiber may be concentrated in one or more areas of an absorbent core layer. In one embodiment, the single layer absorbent core contains a surface-rich layer of the acquisition fiber. Preferably, the surface-rich layer has a basis weight of about 40 gsm to about 400 gsm. Preferably, the surface-rich layer has an area that is about 30% to about 70% of the total area of the absorbent core.

An absorbent core made in accordance with various embodiments preferably contains SAP in an amount of from about 20% to about 60% by weight, based on the total weight of the composite absorbent core, and more preferably from about 30% to about 60% by weight, based on the total weight of the composite. The SAP may be distributed throughout an absorbent core within the voids in the fiber. Alternatively, the superabsorbent polymer may be attached to acquisition fiber via a binding agent. Suitable binding agents include, for example, a material capable of attaching the SAP to the fiber via hydrogen bonding, (see, for example, U.S. Pat. No. 5,614,570, the disclosure of which is incorporated by reference herein in its entirety).

An absorbent core containing acquisition fiber and superabsorbent polymer preferably has a dry density of between about 0.1 g/cm³ and 0.50 g/cm³, and more preferably from about 0.2 g/cm³ to 0.4 g/cm³.

In order that the various embodiments may be more fully understood, the embodiments will be illustrated, but not limited, by the following examples. No specific details contained therein should be understood as a limitation to the embodiments except insofar as may appear in the appended claims.

Test Methods:

ISO Brightness

ISO Brightness evaluations were carried out on various samples of the acquisition fiber in sheet and fluff form, using TAPPI test methods T272 and T525. Selected samples of the acquisition fiber in sheet form were defiberized by feeding them through a hammermill, and then about 5.0 g of the defiberized fluff was airlaid into a circular test sample having approximately a 60 mm diameter. The resultant samples were compressed to a density of about 0.1 g/cm³ then evaluated for ISO brightness.

Fiber Quality

Fiber quality evaluations were carried out on a Fluff Fiberization Measuring Instrument (Model 9010, Johnson Manufacturing, Inc., Appleton, Wis., USA). The Fluff Fiberization Measuring Instrument is used to measure knots, nits and fine contents of fibers. In this test, a sample of fiber in fluff form was continuously dispersed in an air stream. During dispersion, loose fibers passed through a 16 mesh screen (1.18 mm) and then through a 42 mesh (0.36 mm) screen. Pulp bundles that remained in the dispersion chamber (“knots”) and those that were trapped on the 42-mesh screen (“accepts”) were removed and weighed. The combined weight of these two was subtracted from the original weight of the fluff sample to determine the weight of fibers that passed through the 0.36 mm screen (“fines.”)

The Absorbency Test Method

The absorbency test method was used to determine the absorbency under load, absorbent capacity, and centrifuge retention capacity of acquisition fiber of the embodiments. The absorbency test was carried as follows: The test was performed using a plastic cylinder with one inch inside diameter having a 100-mesh metal screen attached to the base of the cylinder. Into the cylinder was inserted a plastic spacer disk having a 0.995 inch diameter and a weighs about 4.4 g. The weight of the cylinder assembly was determined to the nearest 0.001 g (W₀), and then the spacer was removed from the cylinder and about 0.35 g (dry weight basis) of acquisition fiber was air-laid into the cylinder. The spacer disk then was inserted back into the cylinder on the air-laid fibers, and the cylinder assembly was weighed to the nearest 0.001 g (W₁). Fibers in the cell were compressed with a load of 4.0 psi for 60 seconds, the load then was removed and the fiber pad was allowed to equilibrate for 60 seconds. The pad thickness was measured, and the result was used to calculate the dry bulk of acquisition fiber.

A load of 0.3 psi then was placed on the spacer over the fiber pad and the pad was allowed to equilibrate for 60 seconds, after which the pad thickness was measured, and the result was used to calculate the dry bulk under load of the cellulosic based acquisition fibers. The cell and its contents then were hanged in a Petri dish containing sufficient amount of saline solution (0.9% by weight NaCl) to touch the bottom of the cell and the fiber was allowed to stay in contact with the saline solution for 10 minutes. Then it was removed and hanged in another empty Petri dish and allowed to drain for one minute. The load was removed and the weight of the cell and contents was determined (W₂). The weight of the saline solution absorbed per gram fibers then was calculated according to Equation (1) below, the result of which was expressed as the “absorbency under load” (g/g).

$$\frac{{W}_{2} - {W}_{1}}{{W}_{1} - {W}_{0}} \qquad ( 1 )$$

The absorbent capacity of the acquisition fiber was determined in the same manner except that the experiment was carried under zero load. The results were used to determine the weight of the saline solution absorbed per gram fiber and expressed as the “absorbent capacity” (g/g).

The cell then was centrifuged for 3 minutes at 2400 rpm (Centrifuge Model HN, International Equipment Co., Needham HTS, USA), and the weight of the cell and contents is reported (W₃). The centrifuge retention capacity was then calculated according to Equation (2) below, the result of which was expressed as the “centrifuge retention capacity” (g/g).

$$\frac{{W}_{3} - {W}_{0}}{{W}_{1} - {W}_{0}} \qquad ( 2 )$$

Specific Absorption Rate Test (SART)

The SART test method evaluates the performance of the acquisition fibers in an absorbent article. To evaluate the acquisition property of the cross-linked fibers, the acquisition time is measured, which is the time required for a dose of saline to be absorbed completely into an absorbent article comprised of absorbent core and an acquisition layer.

Test samples in the SART test method are comprised of two layers: an acquisition/distribution layer and an absorbent core. In this test, a standard absorbent core was selected as a core sample for all test samples. An airlaid pad (having a basis weight of 120 gsm) made from the acquisition fibers of the embodiments was used as an acquisition/distribution layer, superimposed on the core sample. The acquisition/distribution layer and the core sample were cut into a test sample having a circular shape with a 60 mm diameter. The test sample was placed into a testing apparatus (obtained from Portsmouth Tool and Die Corp., Portsmouth, Va., USA) consisting of a plastic base and a funnel cup. The base is a plastic cylinder having an inside diameter of 60.0 mm that is used to hold the sample. The funnel cup is a plastic cylinder having a hole with a star shape at the bottom, the outside diameter of which is 58 mm. The test sample was placed inside the plastic base, and the funnel cup was placed inside the plastic base on top of the test sample. A load of about 0.6 psi having a donut shape was placed on top of the funnel cup.

The apparatus and its contents were placed on a leveled surface and the sample was insulted with three successive doses of 9.0 ml of saline solution, (0.9% by weight NaCl), the time interval between doses being 20 minutes. The doses were added with a Master Flex Pump (Cole Parmer Instrument, Barrington, Ill., USA) to the funnel cup. The time (in seconds) required for the saline solution of each dose to disappear from the funnel cup was recorded and expressed as “acquisition time,” or “strikethrough.” The time required for the third dose to be absorbed completely by the test sample was recorded as the “third insult strikethrough time.”

### EXAMPLES

### Example 1

This example illustrates a representative method for making a treatment composition solution and using the solution in making acquisition fiber in sheet form.

Cyclohexanedimethanol diglycidyl ether (6.25 g) was added to an aqueous solution of citric acid (35.0 g, 50% in water). The produced suspension mixture was stirred at room temperature. After about 30 minutes, an exothermic reaction started and the stirring was continued until a slightly viscous, water white solution was produced (about 30 minutes). The solution was stirred for at least another 6 hours, and then it was diluted with distilled water to adjust the weight of the solution to about 400 grams. The pH was then adjusted to about 2.9 to 3.3 with an aqueous solution of NaOH (3.5 g, 50 weight %). After stirring for a few minutes, sodium hypophosphite (6.0 g, 50% by weight in water) was added. The stirring was continued for few more minutes after which a white water solution was produced. More water was added to adjust the weight of the treatment composition solution to about 500 grams to provide a solution with about 4.75% by weight treatment composition and 1.2% by weight catalyst. The produced solution then was used to make acquisition fiber in the sheet form.

The treatment composition solution was then used to treat hand sheets of fluff pulp obtained from a jumbo roll of Rayfloc®-J-LD (conventional wood fluff pulp, commercially available from Rayonier, Inc., Jesup, Ga.). The hand sheets measured 12 inches by 12 inches and had a basis weight of about 680 gsm (g/m²). Each hand sheet was dipped in the treatment composition solution, then pressed to achieve the desired level of treatment composition solution (100% wet pick-up). The treated sheet was then dried and cured at about 190° C. The curing was carried out in an air-driven laboratory oven for about 11 minutes to produce acquisition fiber in sheet form. One of the sheets was defiberized by feeding it through a hammermill (Kamas Mill H01, Kamas Industries AB, Vellinge, Sweden), and the others were treated with an aqueous solution of hydrogen peroxide as described in Example 5. Absorbent properties and fiber quality of the produced acquisition fibers were then evaluated, the results of which are summarized in Tables 1 and 2, below.

### Example 2

This example illustrates another method for making a treatment composition solution and using the solution in making acquisition fiber in sheet form.

In this example, the procedure described in Example 1 was followed, except that no adjustment was made to the pH of the treatment composition solution, so that the pH of the solution was about 1.94. In addition, sodium hydrogen phosphate monobasic (NaH₂PO₄) was used as a catalyst. Hand sheets were treated to form acquisition fiber samples. Absorbent properties and fiber quality of the produced acquisition fibers were then evaluated, the results of which are summarized in Tables 1 and 2, below.

### Example 3

This example illustrates a representative method for making acidic acquisition fiber (acquisition fiber with low pH).

In this example, the procedure described in Example 2 was followed except that no catalyst was added to the treatment composition solution. Hand sheets were treated to form acquisition fiber samples. Absorbent properties and fiber quality of the produced acquisition fibers were then evaluated, the results of which are summarized in Tables 1 and 2, below.

TABLE 1
Absorbent properties of acquisition fiber prepared using
treatment compositions of Examples 1, 2 and 3

| | Absorbency | Absorbent | Centrifuge |
|---|---|---|---|
| | Under Load | Capacity | Retention |
| Acquisition fiber | (g/g OD) | (g/g OD) | (g/g OD) |
| Control¹ | 10.3 | 11.4 | 0.93 |
| Example 1 | 9.2 | 11.2 | 0.58 |
| Example 2 | 9.2 | 11.1 | 0.57 |
| Example 3 | 10.2 | 12.0 | 0.60 |

¹Untreated Rayfloc ®-JLD

TABLE 2
Fiber quality of acquisition fibers
prepared using treatment compositions of Examples 1, 2 and 3

| | Knots and nits | Fines | ISO |
|---|---|---|---|
| Acquisition fiber | (%) | (%) | Brightness |
| Control¹ | 9.9 | 4.73 | 87.0 |
| Example 1 | 16.3 | 5.6 | 79.0 |
| Example 2 | 12.3 | 6.9 | 81.9 |
| Example 3 | 4.0 | 9.0 | 80.5 |

¹Untreated Rayfloc ®-JLD

The results in Tables 1 and 2 demonstrate that cellulosic fibers treated with the treatment compositions of the embodiments have absorbency and fiber quality that are comparable with the base fiber. Fibers treated with the treatment composition showed lower centifuge retention capacities, which indicates that the fiber is desirable for use as acquisition/distribution fiber.

### Example 4

This example illustrates a representative method for measuring the pH of the acquisition fiber. 10.0 g of acquisition fiber was saturated with distilled water (50.0 g). The produced mixture was left for about 10.0 minutes, after which about 10.0 grams of liquid was squeezed out of the fiber. The pH of the squeezed liquid was measured and used as the pH of the fiber.

TABLE 3
pH of acquisition fibers prepared using
treatment compositions of Examples 2 and 3

| Acquisition fiber | pH |
|---|---|
| Example 2 | 3.12 |
| Example 3 | 2.61 |

### Example 5

This example illustrates another method for making acquisition fiber in sheet form with the addition of an odor removing and brightening agent.

In this example, sheets of acquisition fiber prepared in accordance with Example 1 were further treated with various odor removing and brightening agents. The treatment was carried out as follows: six aqueous odor removing and brightening solutions were prepared: four containing varying concentrations of hydrogen peroxide (0.1%, 0.25%, 0.5%, and 1.0% by weight of solution); one containing β-Cyclodextrin (0.5% by weight); and one control (containing only water). Several sheets of acquisition fiber prepared in accordance with Example 1 (12 inch×12 inch sample with a basis weight of about 680 gsm), were dipped into one of the odor removing and brightening solutions, then pressed to about a 100% wet pick-up. For example, the sheet dipped in the 0.25% H₂O₂ solution provided about 0.25 weight % of hydrogen peroxide onto the fiber, based on the weight of the fiber. The sheets were then dried in an oven set at about 120° C. The odor and the brightness of the resultant sheets were evaluated, the results of which are reported in Table 4 below. The sheets were then defiberized by feeding them through a hammermill, and the brightness, absorbency, and fiber quality of the produced fibers were measured, the results of which are reported in Tables 5 and 6, below.

TABLE 4
ISO Brightness of acquisition fiber in sheet form treated with various
concentrations of hydrogen peroxide made in accordance with an
Example 5

| Hydrogen peroxide | ISO Brightness after |
|---|---|
| (wt %) | treatment with H₂O₂ |
| 0.00 | 76.0 |
| 0.10 | 81.8 |
| 0.25 | 82.4 |
| 0.50 | 83.7 |
| 1.00 | 84.0 |

TABLE 5
Absorbent properties of acquisition fibers in fluff form treated
with various concentrations of hydrogen peroxide made in accordance
with an Example 5

| | Absorbency | Absorbent | Centrifuge |
|---|---|---|---|
| Hydrogen peroxide | Under Load | Capacity | Retention |
| (wt %) | (g/g OD) | (g/g OD) | (g/g OD) |
| 0.00 | 9.2 | 11.2 | 0.58 |
| 0.10 | 10.0 | 12.4 | 0.55 |
| 0.25 | 10.2 | 12.4 | 0.56 |
| 0.50 | 9.6 | 12.3 | 0.55 |
| 1.00 | 10.1 | 12.3 | 0.59 |

TABLE 6
Fiber quality of acquisition fibers in fluff form treated with various
concentrations of hydrogen peroxide according to Example 5

| Hydrogen peroxide | Knots and | | ISO |
|---|---|---|---|
| (wt %) | nits (%) | Fines (%) | Brightness |
| 0.00 | 16.3 | 5.6 | 79.0 |
| 0.10 | 15.5 | 4.4 | 82.2 |
| 0.25 | 16.8 | 3.6 | 82.9 |
| 0.50 | 14.9 | 4.8 | 84.0 |
| 1.00 | 13.2 | 6.2 | 84.5 |
| 0.50% β-CD, 0.00% | 13.1 | 1.6 | 82.3 |
| H₂O₂¹ | | | |

¹β-Cyclodextrin was applied to the acquisition fiber in sheet form made in accordance with Example 1, by spraying an aqueous solution containing about 5%β-CD.

As shown in Tables 4 and 6, the odor removing and brightening agents improve the brightness of the acquisition fibers, in both sheet form and fluff form. The results in Table 5 confirm that treatment with an odor removing and brightening agent does not negatively impact the absorbency of the acquisition fiber. In addition, the odor of the fiber was evaluated before and after the treatment with the odor removing agent. In all samples, it was observed that a burnt-like odor was present in the fiber before treatment, but was not present after being treated with the odor removing agent.

### Example 6

Acquisition fiber made in accordance with an embodiment was tested for liquid acquisition properties using the SART test method described above.

The absorbent core used in this experiment was obtained from a commercially-available absorbent material (NovaThin®, from Rayonier, Inc.), having a basis weight of about 780 gsm and containing about 40% by weight SAP. The core layer weighed about 2.4 g (±0.1 g). Acquisition layers superposed on the core layer of each sample, were produced from air-laid pads of selective acquisition fiber. Each acquisition layer consisted of a 0.68 gram air-laid pad compacted to a density of about 0.08 g/cM³. A control sample was produced having an air-laid acquisition layer comprising conventional Rayfloc® J-LD pulp fiber. The third insult strikethrough time for each test sample was recorded, and is provided in Table 7 below.

TABLE 7
Liquid acquisition time for absorbent articles containing
an acquisition layer having representative acquisition fiber

| Acquisition Fiber/ | 3^{rd} Insult Strikethrough |
|---|---|
| method of preparation | (sec) |
| Control¹ | >45 |
| Example 1 (Before treatment | 7.7 |
| with H₂O₂) | |
| Example 5 (After treatment with | 9.1 |
| H₂O₂ —0.25%) | |
| Example 2 | 9.2 |
| Example 3 (Acidic acquisition | 10.9 |
| fiber) | |

¹Rayfloc ®-J-LD (untreated)

The results in Table 7 show that the acquisition fiber has a significant affect on the acquisition rate of the absorbent core as compared to conventional untreated fluff pulp.

### Example 7

Acquisition fiber made in accordance with the foregoing examples was evaluated for acquisition and rewet performance. The acquisition and rewet test measures the rate of absorption of multiple fluid insults to an absorbent product and the amount of fluid which can be detected on the surface of the absorbent structure after its saturation with a given amount of saline while the structure is placed under a load of 0.5 psi. This method is suitable for all types of absorbent materials, especially those intended for urine-absorption applications.

Acquisition and rewet for acquisition fiber of the present invention were determined using standard procedures well known in the art with slight modification. Test samples were prepared having a standard commercially available absorbent core NovaThin®, from Rayonier, Inc., having a basis weight of about 805 gsm and containing about 40% by weight SAP. The absorbent core was superposed with an acquisition layer having a basis weight of about 240 gsm prepared from an airlaid pad of acquisition fibers. The acquisition layers were prepared as 25 cm×10 cm panels. The core samples were prepared as 40 cm×12 cm panels. Initially, the dry weight of a test sample was recorded. Then the sample was insulted with a 100 mL, fixed volume amount of saline solution (0.9% by weight NaCl), through a fluid delivery column at a 1 inch diameter impact zone under a 0.1 psi load. The time (in seconds) for the entire 100 mL of solution to be absorbed was recorded as the “acquisition time.” Then the test sample was left undisturbed for 30 minutes. This entire procedure was repeated 2 more times on the same wet test specimen and in the same position as before. After the third insult was performed, a previously-weighed a stack of filter paper (e.g., 15 sheets of Whatman #4 (70 mm)) was placed over the insult point on the test sample, and a 0.5 psi load (2.5 kg) was then placed on top of the stack of filter papers on the test sample for 2 minutes. The wet filter papers were then removed, and the wet weight was recorded. The difference between the initial dry weight of the filter papers and final wet weight of the filter papers was recorded as the “rewet value” of the test specimen. All results are summarized in Table 8 below.

TABLE 8
Acquisition and rewet for absorbent articles with
acquisition layers comprised of acquisition fibers

| Sample | Acquisition Time (sec) | | | Rewet |
|---|---|---|---|---|
| (Acquisition Layer) | 1^{st} insult | 2^{nd} insult | 3^{rd} insult | (g saline) |
| Control 1¹ | 38.5 | 28.2 | 31.7 | 7.2 |
| Control 2² | 34.0 | 23.9 | 28.6 | 6.0 |
| Example 1 (Before | 13.0 | 20.9 | 24.2 | 4.3 |
| treatment with H₂O₂) | | | | |
| Example 5— | 14.1 | 16.7 | 23.3 | 3.8 |
| After treatment with | | | | |
| H₂O₂ (0.25%) | | | | |

¹No acquisition layer was used in this control sample.
²Rayfloc ®-J-LD fluff pulp was used in this experiment as an acquisition layer.

The results in Table 8 demonstrate that the acquisition fiber of the embodiments positively impacted the rate of absorption and amount of rewet of the absorbent products. As can be seen from Table 8 the acquisition fibers of the embodiments significantly reduced the acquisition times and rewet amounts when compared to a control without an acquisition layer and a control with an acquisition layer made from conventional untreated wood fiber. Also, the data in Tables 7 and 8 demonstrate that treatment with hydrogen peroxide has substantially no effect on performance of the acquisition fiber.

While the embodiments have been described with reference to particularly preferred embodiments and examples, those skilled in the art recognize that various modifications may be made thereto without departing from the spirit and scope thereof.

What is claimed is:

1. A method of making acquisition fiber in sheet form having a low degree of yellowing and low odor, said method comprising:
providing a treatment composition solution comprising a cross-linking agent and a modifying agent;
providing cellulosic base fiber in sheet form;
applying the treatment composition solution to the cellulosic base fiber to impregnate the cellulosic base fiber;
drying and curing the impregnated fiber to form acquisition fiber in sheet form;
providing an odor removing agent in aqueous solution; and
applying the odor removing agent to the acquisition fiber.

2. The method of claim 1, wherein the modifying agent is polymeric or monomeric and functions as an anti-hydrogen bonding agent and debonder.

3. The method of claim 1, wherein the cross-linking agent is selected from the group consisting of: a polycarboxylic acid, an aldehyde, a urea-based derivative, and combinations and mixtures thereof.

4. The method of claim 1, wherein the modifying agent is selected from the group consisting of: a polyhydroxy organic compound, a polyfunctional epoxy compound, a silicon based anti-hydrogen bonding agent, and combinations and mixtures thereof.

5. The method of claim 4, wherein the polyfunctional epoxy compound is a compound having formula I or II: 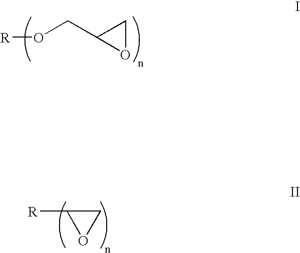
wherein R represents an alkyl group having or more carbon atoms, said alkyl group being a compound that is saturated, unsaturated, substituted, un-substituted, branched, un-branched, cyclic, acyclic, or any combination thereof; and
wherein n represents the number of repeating units, and is a number from 1 to 4.

6. The method of claim 4, wherein the polyfunctional epoxy is selected from the group consisting of: 1,4-cyclohexanedimethanol, 1,3-cyclohexanedimeathonol, 1,2-cyclohexanedimethanol, diacetin, triacetin, tri(propylene glycol), di(propylene glycol), tri(propylene glycol) methyl ether, tri(propylene glycol) butyl ether, tri(propylene glycol) propyl ether, di(propylene glycol) methyl ether, di(propylene glycol) butyl ether, di(propylene glycol) propyl ether, di(propylene glycol) dimethyl ether, 2-phenoxyethanol, propylene carbonate, propylene glycol diacetate, and combinations and mixtures thereof.

7. The method of claim 4, wherein the polyhydroxy organic compound is selected from the group consisting of: cyclohexanedimethanol, diacetin, tri(propylene glycol), di(propylene glycol), tri(propylene glycol) methyl ether, tri(propylene glycol) butyl ether, tri(propylene glycol) propyl ether, di(propylene glycol) methyl ether, di(propylene glycol) butyl ether, di(propylene glycol) propylether, di(propylene glycol) dimethyl ether, 2-phenoxyethanol, propylene carbonate, propyleneglycol diacetate, and combinations and mixtures thereof.

8. The method of claim 4, wherein the silicon-based anti-hydrogen bonding agent is a polymer terminated quaternary amine functional group having formula III or IV: 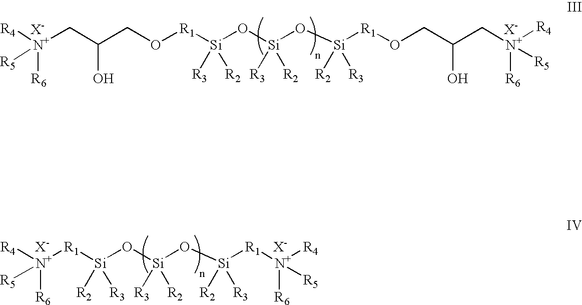
wherein R₁ represents a divalent alkyl group having two or more carbon atoms, said divalent alkyl group being linear, branched or cyclic;
wherein R₂ and R₃ each independently represent a hydrogen atom or an alkyl group with one or more carbon atom;
wherein R₄, R₅ and R₆ each independently represent a hydrogen atom or an organic group selected from the group consisting of: alkyl, aryl, alkoxy, alkaryl, substituted alkyl, cycloaliphatic, aromatic, and combinations and mixtures thereof;
wherein X is anion; and
wherein n represents the number of repeating units, and is a number from 10 to 200.

9. The method of claim 8, wherein the anion X is selected from the group consisting of a halogen ion, an organic carboxylate, hydroxyl, halogen, and a compound with general formula of RSO₃—.

10. The method of claim 1, wherein the cross-linking agent and the modifying agent are mixed in a weight ratio of from about 1:1 to about 100:1.

11. The method of claim 1, wherein the cross-linking agent is a polycarboxylic acid comprising an alkanepolycarboxylic acid selected from the group consisting of: 1,2,3,4-butanetetracarboxylic acid, 1,2,3-propanetricarboxylic acid, oxydisuccinic acid, citric acid, itaconic acid, maleic acid, tartaric acid, glutaric acid, iminodiacetic acid, citraconic acid, tartarate monsuccininc acid, benzene hexacarboxylic acid, cyclohexanehexacarboxylic acid, and mixtures and combinations thereof.

12. The method of claim 1, wherein the cross-linking agent is a polymeric polycarboxylic acid prepared from one or more monomers selected from the group consisting of: acrylic acid, vinyl acetate, maleic acid, maleic anhydride, carboxy ethyl acrylate, itanoic acid, fumaric acid, methacrylic acid, crotonic acid, aconitic acid, acrylic acid ester, methacrylic acid ester, acrylic amide, methacrylic amid, butadiene, styrene, and combinations and mixtures thereof.

13. The method of claim 1, wherein the cross-linking agent is a polycarboxylic acid comprising a combination of polymeric polycarboxylic acid and alkanepolycarboxylic acid.

14. The method of claim 1, wherein the cross-linking agent is an aldehyde selected from the group consisting of: formaldehyde, glyoxal, glyoxylic acid, glutaraldehyde, glyceraldehydes, and combinations and mixtures thereof.

15. The method of claim 1, wherein the cross-linking agent is a urea-based derivative selected from the group consisting of: urea based-formaldehyde addition products, methylolated ureas, methylolated cyclic ureas, methylolated lower alkyl cyclic ureas, methylolated dihydroxy cyclic ureas, dihydroxy cyclic ureas, lower alkyl substituted cyclic ureas, dimethyldihydroxy urea (1,3-dimethyl-4,5-dihydroxy-2-imidazolidinone), dimethylol urea (bis[N-hydroxymethyl]urea), dihydroxyethylene urea (4,5-dihydroxy-2-imidazolidinone), dimethylolethylene urea (1,3-dihydroxymethyl-2-imidazolidinone), glyoxal adducts of urea, polyhydroxyalkyl urea, hydroxyalkyl urea, β-hydroxyalkyl amide, and combinations and mixtures thereof.

16. The method of claim 1, wherein the treatment composition solution has a pH of about 1.0 to about 5.0.

17. The method of claim 1, wherein applying the treatment composition solution to cellulosic base fiber comprises spraying, dipping, rolling, or applying with a puddle press, size press or a blade-coater.

18. The method of claim 1, wherein the treatment composition solution has a concentration of cross-linking agent and modifying agent within the range of from about 3.5 weight % to about 7.0 weight %, based on the total weight of the solution.

19. The method of claim 1, wherein the treatment composition solution is applied to the cellulosic based fiber to provide from about 10% to about 150% by weight of solution on fiber, based on the total weight of the fiber.

20. The method of claim 1, wherein the treatment composition solution is applied to the cellulosic base fiber to provide from about 2% to about 7% by weight of the cross-linking agent and modifying agent on fiber, based on the total weight of the fiber.

21. The method of claim 1, wherein the treatment composition solution further comprises a catalyst.

22. The method of claim 21, wherein the catalyst is an alkali metal salt of phosphorous containing an acid selected from the group consisting of: alkali metal hypophosphites, alkali metal phosphites, alkali metal polyphosphonates, alkali metal phosphates, alkali metal sulfonates, and combinations and mixtures thereof.

23. The method of claim 1, wherein the cellulosic base fiber is provided in a dry or wet state.

24. The method of claim 1, wherein the cellulosic base fiber is a conventional cellulose fiber derived from hardwood cellulose pulp, softwood cellulose pulp, cotton linters, bagasse, kemp, flax, grass, or combinations or mixtures thereof.

25. The method of claim 24, wherein the hardwood cellulose pulp is selected from the group consisting of: gum, maple, oak, eucalyptus, poplar, beech, aspen, and combinations and mixtures thereof.

26. The method of claim 24, wherein the soft cellulose pulp is selected from the group consisting of: Southern pine, White pine, Caribbean pine, Western hemlock, spruce, Douglas fir, and mixtures and combinations thereof.

27. The method of claim 1, wherein the drying and curing occurs in a one-step process conducted for about 3 minutes to about 15 minutes at a temperature within the range of about 130° C. to about 225° C.

28. The method of claim 1, wherein the drying and curing is a two-step process comprising:
first drying the impregnated cellulosic fiber at a temperature below curing temperature; and
curing the dried cellulosic fiber for about 1 to 10 minutes at a temperature within the range of about 150° C. to about 225° C.

29. The method of claim 1, wherein the odor removing agent is selected from the group consisting of hydrogen peroxide, chlorine dioxide, peracetic acid, perbenzoic acid, chlorine, chlorine dioxide, ozone, sodium hypochlorite, baking soda, talc powder, cyclodextrin, ethylenediamine tetra-acetic acid or other chelating agents, zeolites, activated silica, activated carbon granules, DOUBLE-O, UN-DUZ-IT, X-O, NOK-OUT, and combinations and mixtures thereof.

30. The method of claim 1, wherein the odor removing agent performs the functions of removing odor from the acquisition fiber and brightening the acquisition fiber.

31. The method of claim 30, wherein the odor removing agent is selected from the group consisting of hydrogen peroxide, chlorine dioxide, peracetic acid, perbenzoic acid, chlorine, chlorine dioxide, ozone, sodium hypochlorite, baking soda, talc powder, and cyclodextrin.

32. The method of claim 1, wherein applying the odor removing agent to the acquisition fiber comprises spraying, dipping, rolling, printing, or applying with a puddle press, size, press, or a blade-coater.

33. The method of claim 1, wherein the solution of odor removing agent is applied to the acquisition fiber to provide from about 0.05% to about 1.0% by weight of odor removing agent on fiber, based on the total weight of the fiber.

34. The method of claim 1, wherein applying the odor removing agent to the acquisition fiber comprises impregnating the sheet of acquisition fiber with the solution of odor removing agent, pressing the impregnated fiber to remove excess solution, and drying the acquisition fiber at a temperature below 320° F.

35. The method of claim 34, wherein the solution of odor removing agent has a concentration of odor removing agent within the range of about 0.01 weight % to about 20.0 weight %, based on the total weight of the solution.

36. The method of claim 34, wherein the solution of odor removing agent is applied to the acquisition fiber to provide from about 10% to about 150% by weight of solution on fiber, based on the total weight of the fiber.

37. The method of claim 1, wherein applying the solution of odor removing agent to the acquisition fiber comprises treating the surface of the sheet of acquisition fiber with the solution of odor removing agent using a slot coater.

38. The method of claim 37, wherein the solution of odor removing agent has a concentration of odor removing agent within the range of about 0.01 weight % to about 20.0 weight %, based on the total weight of the solution.

39. The method of claim 37, wherein the solution of odor removing agent is applied to the acquisition fiber to provide from about 1% to about 15% by weight of solution on fiber, based on the total weight of the fiber.

40. The method of claim 1, wherein the sheet of cellulosic base fiber is formed using a wet-laid process, and has a basis weight of about 200 grams per square meter (gsm) to about 800 gsm and a density of about 0.15 grams per cubic centimeter (g/cc) to about 1.0 g/cc.

41. The method of claim 1, wherein applying the odor removing agent to the acquisition fiber comprises defiberizing the acquisition fiber, and spraying the odor removing agent onto the defiberized acquisition fiber.

42. The method of claim 1, wherein the treatment composition solution comprises an odor removing agent promoter selected from the group consisting of a metal ion reagent, N,N,N′,N′-tetraacetyldiethylene amine, and combinations and mixtures thereof.

43. The method of claim 1, wherein the odor removing agent promoter is present in the treatment composition solution in an amount sufficient to provide from about 0.001% to about 0.5% by weight to the fiber, based on the weight of the fiber.

44. The method of claim 1, wherein the odor removing agent promoter is selected from the group consisting of ferric pyrophosphate, ferrous oxalate, ferric citrate, ferrous sulfate, ferric ammonium citrate, ferric orthophosphate, ferric ammonium oxalate, ferric ammonium sulfate, ferric bromide, ferric sodium oxalate, ferric stearate, ferric sulfate, ferrous acetate, ferrous ammonium sulfate, ferrous bromide, ferrous gluconate, ferrous iodide, ferric acetate, ferric fluoroborate, ferric hydroxide, ferric oleate, ferrous fumarate, ferrous oxide, ferric lactate, ferric resinate, and any mixture or combination thereof.

45. Acquisition fiber having low degree of yellowing and low odor produced by the method of claim 1.

46. The acquisition fiber of claim 45, having an ISO Brightness of greater than 77%.

47. The acquisition fiber of claim 45, having a pH of less than about 3.5.

48. An absorbent article having a multi-layer absorbent structure comprising:
an upper layer comprising the acquisition fiber of claim 45; and
a lower layer comprising a composite of superabsorbent polymer and cellulosic fibers;
wherein the upper layer has a basis weight of about 40 gsm to about 400 gsm.

49. The absorbent article of claim 48, wherein the upper layer further comprises superabsorbent polymer in an amount ranging from about 1% to about 30% based on the total weight of the upper layer.

50. The absorbent article of claim 48, wherein the cellulosic fibers comprise cellulose fiber derived from hardwood cellulose pulp, softwood cellulose pulp, cotton linters, bagasse, kemp, flax, grass, or combinations or mixtures thereof.

51. The absorbent article of claim 48, wherein the upper layer comprises a blend of cellulosic fibers and acquisition fiber; wherein the cellulosic fibers comprise cellulosic fiber derived from hardwood cellulose pulp, softwood cellulose pulp, cotton linters, bagasse, kemp, flax, grass, or combinations or mixtures thereof.

52. The absorbent article of claim 51, wherein the cellulosic fibers are present in the upper layer in an amount ranging from about 1% to about 70% based on the total weight of the upper layer.

53. The absorbent article of claim 48, wherein the absorbent core comprises a single-layer absorbent structure comprising the acquisition fiber; wherein the single-layer absorbent structure has a surface-rich layer of acquisition fiber having a basis weight of about 40 grams per square meter to about 400 grams per square meter.

54. The absorbent article of claim 53, wherein the surface-rich layer has an area that is 30% to 70% of the area of the single-layer absorbent structure.

55. The absorbent article of claim 48, wherein the upper layer comprises a blend of acquisition fibers and cold caustic-treated fibers.

56. The absorbent article of claim 55, wherein the upper layer comprises from about 1% to about 70% by weight of cold caustic-treated fibers, based on the total weight of the upper layer.

57. The absorbent article of claim 55, wherein the cold caustic-treated fiber is prepared by treating a liquid suspension of pulp at a temperature of from about 5° C. to about 85° C. with an aqueous alkali metal salt solution having an alkali metal salt concentration of about 2 weight percent to about 25 weight percent of said solution for a period of time ranging from about 5 minutes to about 60 minutes.
